(19) United States
(12) Patent Application Publication
(10) Pub. No.: US 2005/0236843 A1
(43) Pub. Date: Oct. 27, 2005

(54) Tidal current accelerating structure for electrical power generation

(76) Inventors: Dominique G. Roddier, Berkeley, CA (US); Christian Cermelli, San Francisco, CA (US)

Correspondence Address: Dominique Roddier, 2610 Marin Ave., Berkeley, CA, 94708, US

(21) Appl. No.: 11/110,311

(22) Filed: Apr. 20, 2005

Related U.S. Application Data
(60) Provisional application No. 60/564,336, filed on Apr. 22, 2004.

(51) Int. Cl. H02P 9/04; F03B 13/00

(52) U.S. Cl. 290/54

(57) ABSTRACT

The present invention relates to an underwater ocean structure designed to increase the velocity of tidal currents and therefore the electrical output of underwater turbines or similar devices positioned within the structure. Existing devices designed to convert ocean current energy into electricity are only economical in areas where available ocean current speed is very high, which restricts their applicability to only a few locations. The present invention will improve the economics of harvesting ocean current power from many coastal areas in the country.

### CROSS REFERENCE TO RELATED APPLICATION

This application is based on provisional Patent Application No. 60/564,336 filed on Apr. 22, 2004 and entitled “Electrical power generation by tidal flow acceleration”.

### BACKGROUND OF THE INVENTION

The present invention relates to an underwater ocean structure designed to increase the velocity of tidal currents in order to increase the electrical output of underwater turbines or similar devices.

Hydropower provides about 10% of the electricity in the US, but the technology in the extraction of energy from ocean currents lags largely behind dams or wave energy devices. This is mainly due to the limited power that can be generated from conventional turbine design in almost all of the coastal waters with only a few exceptions, such as the Gulf Stream offshore Florida. Additionally, the technical challenges of installing and maintaining reliable equipment in high current areas are considerable and associated costs are high.

Several systems have been proposed recently to harness the energy of ocean currents. Patent Application 20040189010 entitled “Hydro-electric farms” describes an array of electrical generators at the bottom of the ocean and Patent Application 20020197148 entitled “Installation for harvesting ocean currents (IHOC)” describes an array of current turbines with fimnels positioned under a floater in a region where ocean currents are available. Economics dictate that such systems must be installed in regions where the ocean current speed is high, typically on the order of 2 m/s or higher, which considerably restricts the number of available locations.

The concept described in this application is aimed at augmenting significantly the ocean currents renewable energy market by minimizing the limitations of ocean currents energy generation.

### SUMMARY OF THE INVENTION

The power generated by a turbine can be estimated as follows: P=c η ρ D² V³ where: P is the electrical power generated by the turbine, η is the efficiency of the system, ρ is the density of the fluid medium, c is a constant, in this case π/8, D is the diameter of the propeller and V is the velocity of the fluid perpendicular to the plane of the propeller. This formula shows that that the amount of energy generated by an ocean current turbine is proportional to the third power of the current velocity. An increase in incoming current velocity will therefore results in a significant increase in produced power.

Many coastal areas in the US have tidal currents on the order of 1.0 to 1.5 m/s, which is not sufficient to economically produce electricity using the apparatuses described in paragraph [0004]. The primary goal of the proposed device is to increase the speed of tidal currents by placing on the seabed a large structure composed of vertical walls and forming channels in which current turbines or similar devices able to convert current flow into electrical energy will be positioned.

The structure will be designed to resist maximum loads due to the high currents in and around the structures, as well as wave loads resulting from storms. The material composing the structure will be suitable for use in an offshore environment with no significant degradation of the performance during the operating life of the structure.

Current turbines will be placed in areas of accelerated flow to convert the current energy into electricity. A submerged electrical cable will bring the electrical power to the shore where it will be distributed to the consumers.

### BRIEF DESCRIPTION OF THE DRAWINGS

FIG. 1 is a plane view of the structure of the present invention and its effect on the current velocity field within the structure.

FIG. 2 is a perspective view of a preferred embodiment of the present invention.

### DETAILED DESCRIPTION OF THE INVENTION

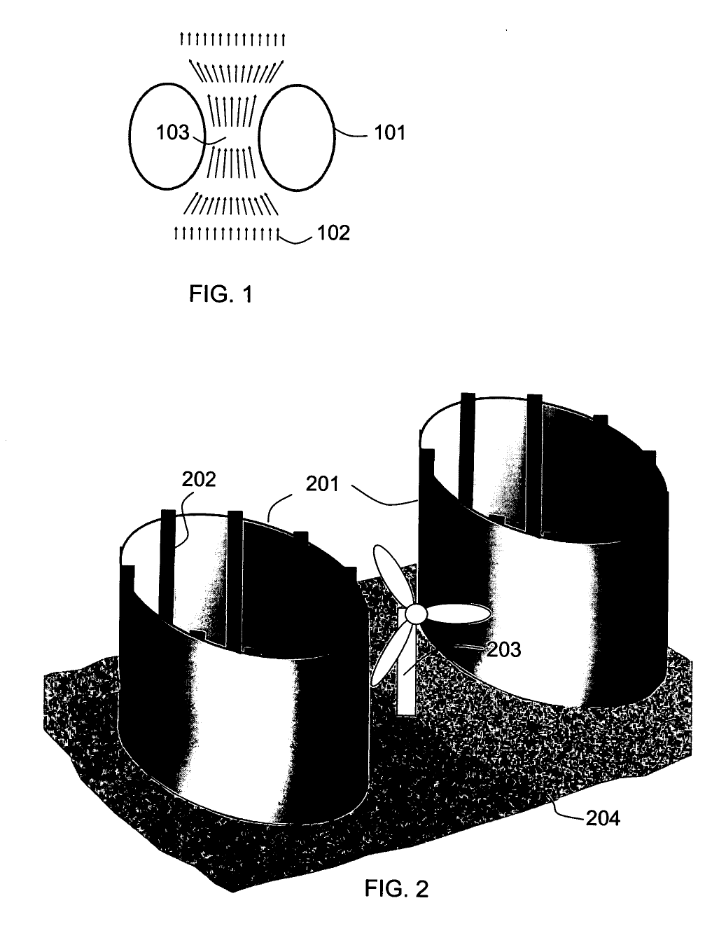

FIG. 1 illustrates the physical phenomenon from which the present invention is derived. The Tidal Current Accelerating Structure 101 is placed in an ocean current field with incoming current speed represented by the arrows 102. Higher pressure areas resulting from the obstructions to the flow caused by the structure forces the flow with higher velocities in the channel formed by the two sides of the structure. High current velocity area 103 is a suitable location for positioning of current energy conversion devices, such as current turbines.

FIG. 2 describes the main elements of the Tidal Current Accelerating Structure (TCAS): 201 represents the vertical walls which serve to modify the incoming current velocity field, and which are positioned on the sea-bed 204. Modern efficient current turbines are relatively large, typically 10 m in diameter, and the height of the TCAS wall is slightly larger. The walls are made of relatively light-weight material, in order to minimize the weight of the structure and associated fabrication and installation costs.

The walls are maintained in place by structural members 202, designed to withstand the loads applied to corresponding sections of the TCAS walls.

One or more current turbines or other energy conversion devices 203 are positioned in areas of increased current velocity.

Multiple such structures may be placed side-by-side or in an array that will result in increased current speed over a large area.

The TCAS structure is primarily designed to act upon tidal currents, because their frequency and amplitude is highly predictable, but similar effects could be obtained in any ocean current.

The structure is streamlined in order to minimize flow separation, and turbulence effects which would reduce the efficiency of the power conversion devices.

While the illustrative embodiments of the invention have been described with specific details, it is understood that various modifications can be readily made by those skilled in the art without departing from the spirit and scope of the invention. Accordingly, the scope of the claims appended hereto is not limited to the description provided herein but encompasses all the patentable features of the present invention, including all features which would be treated as equivalents thereof by those skilled in the art to which this invention pertains.

1. A submerged structure positioned on the seabed and aimed at locally increasing the velocity of ocean currents, in order to increase electrical power generation from current turbines or similar devices.

2. The structure of claim 1, further comprising substantially vertical walls shaped such as to form a channel in which the tidal current velocity is higher than the incoming tidal current velocity.

3. The structure of claim 2, further comprised of substantially vertical walls made of light-weight man-made materials.

4. A plurality of the structures of claim 2 arranged side-by-side and resulting in increased tidal current velocity over the area covered by the structures.

5. A method of increasing electrical output of ocean current turbines or similar devices by providing a submerged structure which increases the ocean current velocity in a region of the structure where current turbines or similar devices are positioned.

6. The method of claim 5, wherein the structure is composed of substantially vertical walls forming a channel in which the tidal current velocity is higher than the incoming tidal current velocity.
